(19) United States
(12) Patent Application Publication
(10) Pub. No.: US 2024/0421424 A1
(43) Pub. Date: Dec. 19, 2024

(54) BATTERY THERMAL RUNAWAY VENT ASSEMBLY WITH EXPANDED METAL FILTER ELEMENT

(71) Applicant: ACS Industries, Inc., Lincoln, RI (US)

(72) Inventor: Steven D. Huntsman, Ogden, UT (US)

(73) Assignee: ACS Industries, Inc., Lincoln, RI (US)

(21) Appl. No.: 18/817,879

(22) Filed: Aug. 28, 2024

Related U.S. Application Data
(62) Division of application No. 17/714,602, filed on Apr. 6, 2022.
(60) Provisional application No. 63/281,346, filed on Nov. 19, 2021.

(51) Int. Cl. H01M 50/383; H01M 10/0525; H01M 10/613; H01M 50/325; H01M 50/358; H01M 50/367

(52) U.S. Cl. CPC H01M 50/383; H01M 50/325; H01M 50/358; H01M 50/367; H01M 10/0525; H01M 10/613

(57) ABSTRACT

A battery exhaust vent includes an expanded metal filter which acts as a heat sink to cool an overheating battery. The exhaust vent acts as a particulate filter and flame arrestor which reduces flames and particulate slag projectiles from being expelled outside a battery housing. Directional Flow Expanded Metal (DFEM) and Variable Expanded Metal (VEM) are utilized for their directional fins and associated plethora of openings offset in overlapping layers to create a cyclone effect for gases or particles passing through the filter. The fins and holes are offset from layer to layer within a multi-layer filter construction and are designed to immediately change the direction of the flames and burning particles relative to the input flame flow direction. The vent may include an elastomeric umbrella valve which seals the vent from external airflow but allows quick venting for internal gas pressure during a runaway event or excessive heating.

### CROSS-REFERENCE TO RELATED APPLICATIONS

This application is a divisional application of U.S. patent application Ser. No. 17/714,602, filed Apr. 6, 2022, which is related to and claims priority from earlier filed U.S. Provisional Patent Application No. 63/281,346, filed Nov. 19, 2021, the entire contents of which is incorporated herein by reference.

### BACKGROUND OF THE DISCLOSURE

The present disclosure relates generally to venting of byproduct heat from batteries. More specifically, the present disclosure provides to a venting assembly for mitigating thermal runaway events that may occur in relation to rechargeable battery packs or housings.

Thermal runaway is a catastrophic battery failure event which is a cascade failure that begins when the heat generated inside a rechargeable battery cell, such as a lithium-ion battery cell, is not dispersed to its surroundings. Thermal runaway can occur due to a number of operational factors including, but not limited to overcharging, end of life age, float charge voltage, and external battery damage, such as for example in an automotive accident. If the excess heat that is generated is not fully or partially remedied by heat mitigators or vents, an unplanned runaway condition could result in a catastrophic failure.

Once internal battery temperatures rise too high without mitigation (as low as 250 degrees F. in as little as four minutes time duration), a domino effect happens where a battery cell or cells can begin to catastrophically fail, such a failure can then further increase the reaction rates. Such an event with a suspect battery can quickly lead to sudden system failure, an explosion with burning projectiles, and/or an uncontrolled fire.

Vent assemblies for rechargeable battery packs are known in the industry. Known vent assemblies provide pressure equalization and mitigation of gas pressure buildup inside the battery pack during both normal operation and runaway events. The vents also include features that guard against contaminants, dirt, water, etc., while also providing pressure equalization with the ambient environment. Further these vents provide heat ventilation for temperature cycling during normal operation. While the existing vents will provide an escape route for large amounts of gas and pressure build up during a runaway event, such existing vents do not offer any protection from heat, flame or projectiles that may be generated and expelled from the battery housing in the event of an explosive failure or battery fire.

### SUMMARY OF THE DISCLOSURE

The present disclosure provides a novel battery vent assembly that includes an expanded metal filter element which acts as a heat sink to cool and overheating battery. Further, the vent assembly acts as a particulate filter and flame arrestor which prevents and/or reduces flames and particulate slag projectiles from being expelled outside an individual cell or bank of cells in a battery.

The disclosure employs Directional Flow Expanded Metal (DFEM) and Variable Expanded Metal (VEM) filter technology as a failsafe device to mitigate an unplanned thermal runaway event inside a lithium-ion battery system and to capture any potential explosive particles and arrest flames preventing the unwanted propagation of flames and debris outside the battery.

In some embodiments, the filter element is formed as a multilayer cylindrical collar. In other embodiments, the filter element is a flat multilayer filter element.

A VEM/DFEM filter element utilizes directional fins and associated plethora of openings offset in overlapping layers to create a light weight, low-cost tortuous path centrifuge or cyclone effect for gases or particles passing through the filter. The fins and holes are offset from layer to layer within the wrap of the collar filter and are designed to immediately spin the flames and burning particles into a 90 degree pathway in relation to the input flame flow direction. This spinning of the flame and the offset layer to layer, creates a cooling effect to act as a thermodynamic heat sink (at both sub-sonic or supersonic mass flow, flaming gas speeds) and to further arrest the flame by forcing the flame particles one direction while allowing the cleaned, cooled air generated by the heating battery source, to more easily move different from, or opposite to the flaming particles. As a result, air flows more freely at a cool temperature, to collar the flame in as low as 5 milliseconds, before any flames or particles reaches a battery vent exit port.

Once a thermal runaway ignites into a flame, the flame can burn and or explode into burning projectiles very fast inside a battery. The collar filter vent must separate the flaming particles in as low as only a few milliseconds of time. Thus, the filter's vent openings are sized differently in each successive layer. The openings are sized on a gradient, so as not to aggressively hamper a slag filled flaming fluid-flow. This avoids a collar from prematurely plugging with slag. The collar filter can do this once the particles are removed by creating more fine holes that can be added more quickly into the filter layers to filter smaller and smaller burning particles more quickly while avoiding a plug which can create undo internal battery backpressure.

The particles in the flame, as well as the undesirable external battery heat are thus better trapped inside the subsequent layers of the metal heat sink filter as “captured flame” particles, and the generated air is able to exit the battery system being less incumbered at a far cooler temperature that is reduced by up to 90% of its burning flame temperature in less than one second time.

Testing has shown that flames and particles of a burning gas generate (lab mockup) are better removed up to 100% with DFEM and or VEM acting as a collar filter vent, and with far less filter weigh than non-variable layers, and non-cyclone type collar filters.

### BRIEF DESCRIPTION OF THE DRAWINGS

Exemplary embodiments will now be described further by way of example with reference to the following examples and figures, which are intended to be illustrative only and in no way limiting upon the scope of the disclosure.

FIG. 1 is a perspective view of an exemplary vehicle battery pack incorporating the vent assembly of the present disclosure;

FIG. 2 is a perspective view of an exemplary vent assembly;

FIG. 3 is an exploded perspective view thereof;

FIG. 4 is a cross-section view thereof taken along line 4-4 of FIG. 2;

FIG. 5 is an enlarged view of an expanded metal filter collar;

FIG. 6 is a plan view of a strip of expanded metal prior to rolling into a filter collar;

FIG. 7 is a perspective view of another exemplary embodiment utilizing a flange collar for attachment;

FIG. 8 is an exploded view of a further exemplary embodiment including a pressure equalization membrane;

FIG. 9 is an exploded view of yet a further exemplary embodiment including a pressure equalization membrane and an elastomeric umbrella valve;

FIG. 10 is a perspective view of another exemplary vent assembly of the present disclosure with a planar multi-layer filter and vent openings in the top wall of the vent housing; and

FIG. 11 is an exploded perspective view thereof.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

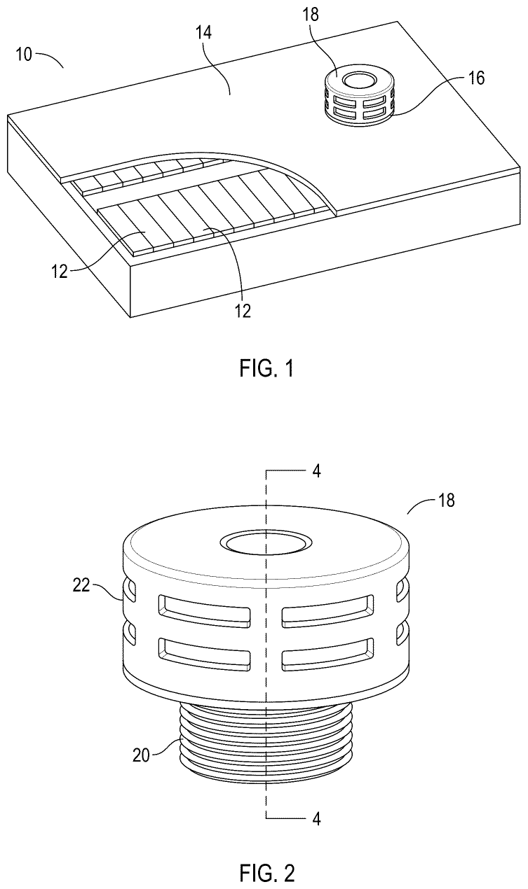

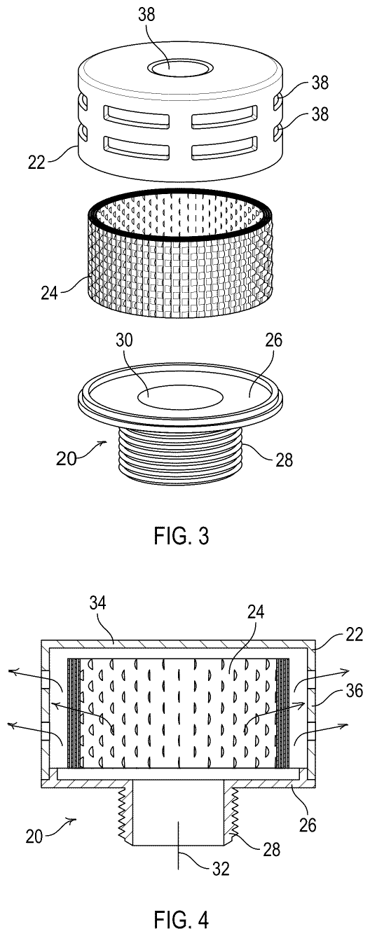

FIG. 1 illustrates an exemplary rechargeable battery assembly 10 which may comprise a single battery cell or multiple battery cells 12 or packs nested together within a protective housing or enclosure 14. Typically, such enclosures 14 are formed of metal for protection and structural stability when used in vehicles that could be involved in accidents. The housing 14 may include a vent opening 16 in which a vent assembly 18 may be installed. An exemplary vent assembly 18 according to the present disclosure is illustrated in FIGS. 1-6 of the drawings.

Turing to FIGS. 2-4, an exemplary vent assembly 18 may comprise a vent base portion 20, a vent cover portion 22 and an internal expanded metal filter collar 24. The vent base 20 and vent cover 22 may be formed, stamped or machined from a metal or metal alloy material, or any other material which may be suitable for automotive applications and capable of sufficiently withstanding a destructive fire or explosive event within the battery housing 14.

The vent base portion 20 may have a cylindrical bottom wall 26 with a vent port 28 extending downwardly. The exterior of the vent port 28 may be threaded for removable assembly to the vent opening 16 in the battery housing 14. A vent path 32 extends through the vent port 28 and through an opening in the bottom wall 30 into the interior of the vent assembly 18. The vent cover 22 has a top wall 34 and downwardly extending sidewalls 36 which are secured to the base portion 20 by welding or other fastening means consistent with automotive manufacturing standards. The top wall 34 and/or sidewalls 36 may have vent openings 38 therein through which gases may enter or exit. Directional flow of gas out of the vent may be seen by the arrows in FIG. 4.

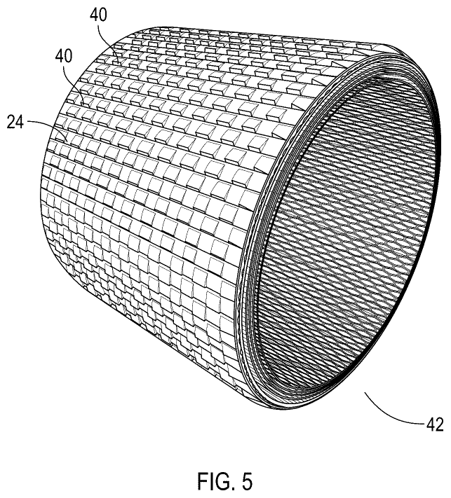

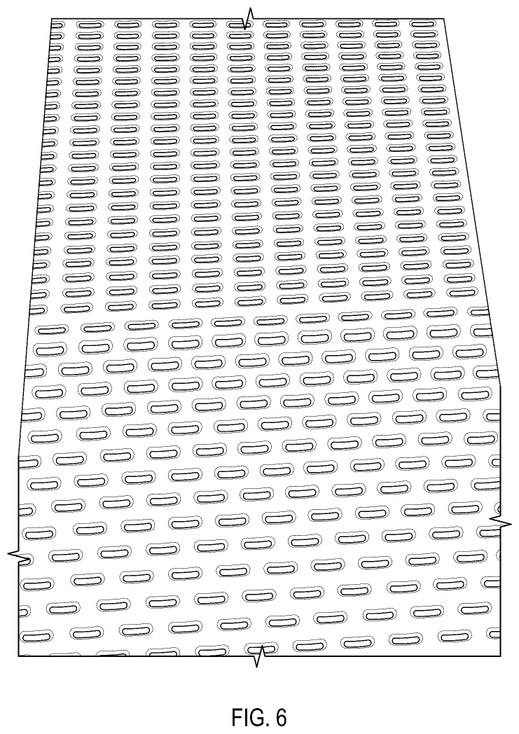

Turning to FIGS. 5 and 6, there are shown images of an exemplary expanded metal filter collar 24 (FIG. 5), as well as a sheet of expanded metal prior to rolling and forming into a formed filter collar 24. The expanded metal filter collar 24 is made from either a sheet of VEM or DFEM which is found with a plurality of slits 40 and stretched openings which is manufactured without any drop or scrap unlike perforated metal. In FIG. 5, the expanded metal can be seen rolled in multiple adjacent layers 42 to form the metal filter collar 24. These slit openings 40, which were simultaneously slit and stretched open, provide airway flow paths that are designed to turn the burning flame particles in a different direction then the flowing burning gas path to quickly dissipate the flame and flame heat, and or burning projectile particles.

The shape of the slit opening 40 and or fins in the collar vents provide the advantage to force the flame path to be longer than it would in a traditional flow path, which go nearly straight through a wire mesh vent opening, or straight expanded metal filters, or perforated metal, or wire wound filer openings. This longer vent flow path in a VEM or DFEM filter collar can extinguish the flame in as little as 2 offset row layers by creating turbulence of the flame stream, which is highly desired when trying to either remove the flame quickly, and the resultant generated high temperature particle filled gases.

As illustrated in FIG. 6, it should also be noted that the design of the opening slits 40 can be placed in different locations along the expanded metal sheet 44 so that when the sheet 44 is rolled, different openings 40 are adjacent one another layer to layer, or wrap to wrap of the collar vent 24 filter. This offset placement of the slits 40, layer to layer, which are in intimate or direct contact with one another which further helps to create flame turbulence and rapid heat removal as a result of the resultant flame phase change. Thus, by using offset DFEM the flow of the flame filled gas particles will exit one layer and plate out better on the mating layer, directly behind the layer because a flat area without slit openings can be positioned behind a layer with slit openings in its flame flow path.

Further details regarding Directional Flow Expanded Metal (DFEM) and Variable Expanded Metal (VEM) Filters may be found in U.S. Pat. No. 10,717,032 (Greenwood et. al), as well as in U.S. Pat. No. 10,676,062 (Adamczyk et. al.), the entire contents of which are incorporated herein by reference.

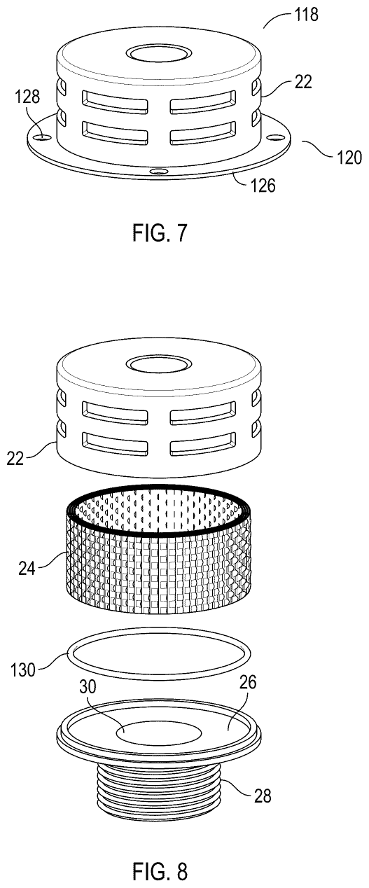

FIG. 7 illustrates another exemplary vent assembly 118 wherein the vent base portion 122 includes a mounting flange 126 in the place of the threaded vent port 28. The vent assembly 118 may be secured to the battery housing 14 by means of fasteners extending through holes 128 the mounting flange 126. Otherwise, the vent assembly 118 is the same in construction and operation as previously described.

FIG. 8 illustrates another exemplary embodiment which further includes a pressure equalization membrane 130 disposed over the vent opening. The equalization membrane 130 may be made from a PTFE or EPTFE material to provide for atmospheric equalization, while keeping out dust and moisture.

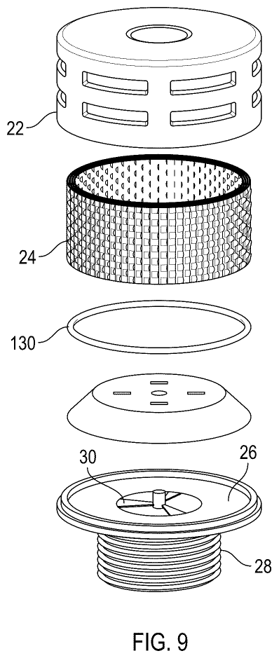

FIG. 9 illustrates a further exemplary embodiment including both a pressure equalization membrane 130 and an elastomeric umbrella valve 132 which seals the vent from external airflow but allows quick venting for internal gas pressure during a runaway event or excessive heating.

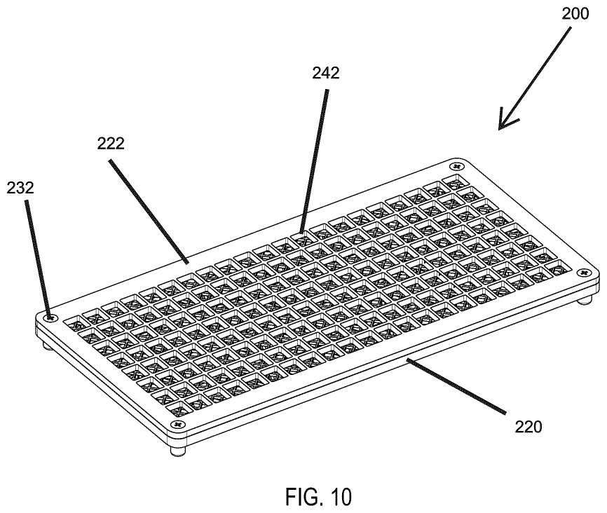

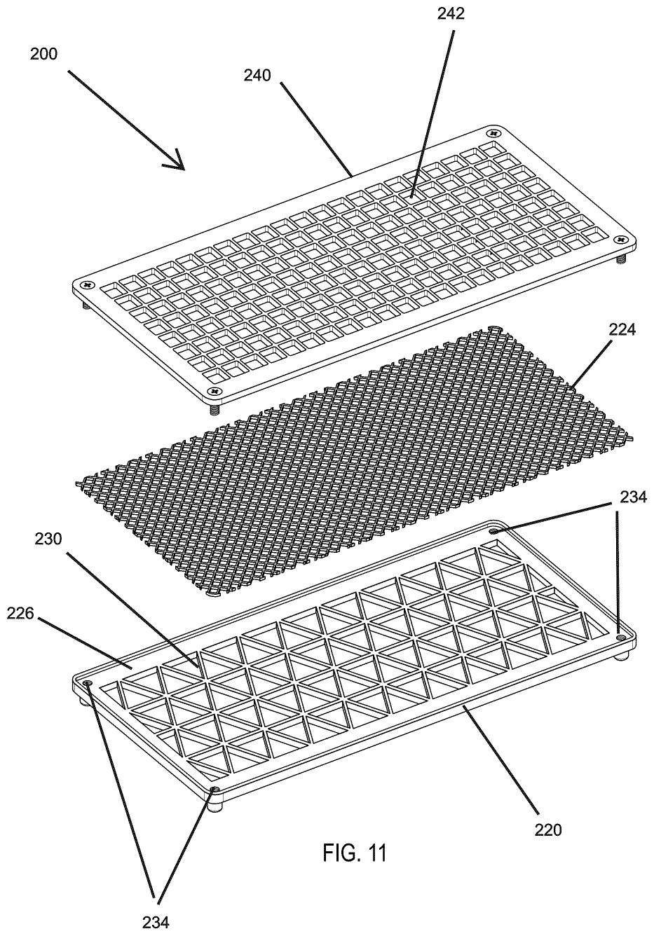

Turning to FIGS. 10 and 11, there is shown and described another exemplary vent assembly 200 which is planar in geometry. The vent assembly 200 may comprise a vent base portion 220, a vent cover portion 222 and an internal multilayer expanded metal filter element 224. The vent base 220 and vent cover 222 may be formed, stamped or machined from a metal or metal alloy material, or any other material which may be suitable for automotive applications and capable of sufficiently withstanding a destructive fire or explosive event within a battery housing 14.

The vent base portion 220 may be rectangular, square, circular or any other suitable geometry to match a corresponding vent port on the battery housing 14, and may have a bottom wall 226 with one or more vent ports or openings 230. The vent assembly 200 may be secured to the battery housing 14 by means of fasteners 232 extending through aligned openings 234 in the vent base 220 and cover 222. The vent cover 222 has a top wall 240 and may have one or more vent openings 242 therein through which gases may enter and exit.

Referring back to FIGS. 5 and 6, the planar filter element 224 comprises the same multilayer VEM materials as described hereinabove with respect to the exemplary expanded metal filter collar. However, in this case, the mutlilayer VEM/DFEM, etc. material is laid flat and overlapped, and may be welded or tacked together to maintain orientation and overlapping/offset filter opening alignment creating the same tortious exit path for hot gaseous materials. The present filter element 224 will filter the thermal runaway gases and slag materials straight upwardly through the vent assembly and out of the top.

It can therefore be seen that the exemplary embodiments described herein provide unique and novel thermal runaway vent assembly which is effective for mitigating both heat, flame, and explosive particle discharge from a battery housing. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A battery exhaust vent for filtering and cooling thermal runaway exhaust gases and slag material from a runaway battery comprising:
an exhaust vent housing formed by a vent base portion and a vent cover portion and, having an internal cavity enclosed by a bottom wall of the vent base portion, a top wall of the vent cover portion and side walls,
said vent cover portion having an exhaust vent in the top wall thereof,
said vent base portion having an inlet vent in the bottom wall thereof;
a battery housing attachment structure on the exhaust vent housing;
a vent filter contained in said cavity, wherein said vent filter comprises a directional flow expanded metal (DFEM) sheet or a variable expanded metal (VEM) sheet having openings therein to allow said flow path to pass therethrough,
wherein a flow path from said inlet vent port into said cavity and out said exhaust vent is directed through said vent filter; and
an elastomeric umbrella valve in said flow path which seals the vent from external airflow but allows quick venting for internal gas pressure during a runaway event or excessive heating.

2. The battery exhaust vent of claim 1, wherein said battery housing attachment comprises a flange with holes therein for connection to a battery housing.

3. The battery exhaust vent of claim 1, wherein said vent filter is formed from multiple overlying layers of said expanded metal sheet.

4. The battery exhaust vent of claim 3, wherein the openings in each subsequent layer are positioned so as not to align with holes in a previous layer.

5. The battery exhaust vent of claim 3, wherein said openings have differing sizes and positioning relative to one another.

6. The battery exhaust vent of claim 1, further comprising:
a pressure equalization membrane.

7. The battery exhaust vent of claim 2, wherein said vent filter is formed from multiple overlying layers of said expanded metal sheet.

8. The battery exhaust vent of claim 7, wherein the openings in each subsequent layer are positioned so as not to align with holes in a previous layer.

9. The battery exhaust vent of claim 7, wherein said openings have differing sizes and positioning relative to one another.

10. The battery exhaust vent of claim 3, further comprising:
a pressure equalization membrane.

11. The battery exhaust vent of claim 4, further comprising:
a pressure equalization membrane.

12. The battery exhaust vent of claim 5, further comprising:
a pressure equalization membrane.
